(19) United States
(12) Patent Application Publication
(10) Pub. No.: US 2009/0248977 A1
(43) Pub. Date: Oct. 1, 2009

(54) VIRTUAL TAPE APPARATUS, VIRTUAL TAPE LIBRARY SYSTEM, AND METHOD FOR CONTROLLING POWER SUPPLY

(75) Inventor: Kazuma TAKATSU, Kawasaki-shi (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/368,401

(22) Filed: Feb. 10, 2009

(30) Foreign Application Priority Data
Mar. 31, 2008 (JP) 2008-092779

(51) Int. Cl. G06F 12/08; G06F 1/26

(52) U.S. Cl. 711/113; 713/300; 711/E12.017

(57) ABSTRACT

A virtual tape apparatus, which can switch a power supply state to a tape apparatus to thereby suppress power consumption, has an access instruction unit and a power supply control unit. The access instruction unit determines whether or not it is necessary to supply power to a tape apparatus in which a physical tape is stored and which stores data to the physical tape based on an update state of data stored to a tape volume cache, and the power supply control unit switches a state of power supplied to the tape apparatus based on a result of determination executed by the access instruction unit.

### CROSS-REFERENCE TO RELATED APPLICATION

This application is based upon and claims the benefit of priority of the prior Japanese Patent Application No. 2008-92779, filed on Mar. 31, 2008, the entire contents of which are incorporated herein by reference.

### FIELD

The embodiment discussed herein is related to a virtual tape apparatus for virtually operating a physical tape on a magnetic disc apparatus, a virtual tape library system, and a method for controlling power supply.

### BACKGROUND

A virtual tape apparatus is an apparatus for virtually operating a tape on a magnetic disc apparatus by disposing tape image data on a medium, which can be accessed at random, such as a magnetic disc apparatus and the like, as logical volumes (LV). The virtual tape apparatus can realize a high speed process by excluding mechanical operations such as conventional tape mount, load/unload, and the like.

FIG. 1 illustrates an arrangement of an overall virtual tape library system 500 having the virtual tape apparatus 501. The virtual tape library system 500 is composed of the virtual tape apparatus 501, a tape apparatus 502 (tape library), and a host 600 as a main frame when classified roughly. The virtual tape library system 500 shown in FIG. 1 is arranged such that an operation is not stopped even if a fault occurs because it is provided with two systems of control paths from the host 600 (“Left Group” and “Right Group” in the virtual tape apparatus 501 of FIG. 1, and the tape apparatus 502 having two systems) and further a predetermined server and predetermined cable collection equipment that constitute the virtual tape apparatus 501 also has two systems.

An arrangement of the virtual tape apparatus 501 will be explained. The virtual tape apparatus 501 is composed of a plurality of servers each of which realizes the following functions.

A host communication control unit 511 is connected to the host 600 and controls data transmission/reception between the host 600 and the logical volumes on a tape volume cache 516 (TVC 516 in FIG. 1).

An access instruction unit 512 stores data to a physical tape and restores data from the physical tape by instructing a tape read/write execution unit 515 and a robot control unit 514 to access to the physical tape. Further, the access instruction unit 512 receives a mount request from the host 600 and mounts the logical volumes of the tape volume cache 516.

The tape read/write execution unit 515 stores the logical volumes in the tape volume cache 516 to the physical tape by controlling drives 522 of the tape apparatus 502 in response to an instruction from the access instruction unit 512. Further, the tape read/write execution unit 515 reads out data of the physical tape stored to a tape apparatus 502 and restores it on the tape volume cache 516.

The robot control unit 514 controls a robot 521 of the tape apparatus 502 in response to an instruction from the access instruction unit 512.

The tape volume cache 516 is a magnetic disc apparatus composed of RAID, and the data of the logical volumes is stored thereto.

A power supply control unit 513 controls ON/OFF of power supplies of respective servers which realize the above functions in the virtual tape apparatus 501.

The tape apparatus 502 (tape library) stores the physical tape, obtains data from an outside (tape volume cache 516) using the robot 521 as a library controller and drives 522 (DM-O to DM-3) disposed therein and stores the data to the physical tape. Further, the tape apparatus 502 restores the data of the physical tape to the outside (tape volume cache 516).

Note that “HUB” in FIG. 1 is cable collection equipment of a LAN cable in charge of a data communication between the respective servers, and “FC-SW” is cable collection equipment of a fiber channel cable (FC cable) through which the respective servers are connected to the tape apparatus 502. Further, the host 600 is connected to the host communication control unit 511 through OCL INK (registered trademark) so that a high speed communication can be realized.

Next, a control between the respective functions of the virtual tape apparatus 501 and a flow of data will be explained referring to FIG. 2.

The access instruction unit 512 determines whether or not a data request from the host 600 is present on the tape volume cache 516. When the data is not present, the access instruction unit 512 instructs the tape read/write execution unit 515 and the robot control unit 514 to transmit data from the physical tape in the tape apparatus 502 to the tape volume cache 516. After the completion of data transmission from the physical tape to the tape volume cache 516, the access instruction unit 512 instructs the host communication control unit 511 to transmit and receive data to and from the host 600.

Further, the access instruction unit 512 requests the tape read/write execution unit 515 and the robot control unit 514 to write updated data on the tape volume cache 516 to the physical tape in the tape apparatus 502, and the tape read/write execution unit 515 and the robot control unit 514 write the updated data to the physical tape.

In the virtual tape library system 500, a data transmission/reception process to and from the host 600 is executed on the tape volume cache 516 in the virtual tape apparatus 501. Ordinarily, although the logical volumes on the tape volume cache 516 updated by the host 600 are written to the physical tape just after it is updated, timing at which it is written can be changed by setting of a user.

When timing of the writing described above is set, there occurs a period during which data is transmitted and received to and from the host 600 without using the back end unit (unit composed only of functions which are needed for the first time when the tape apparatus 502, the robot control unit 514, the tape read/write execution unit 515, and the like are operated). However, in the conventional virtual tape library system 500 described above, power remains supplied to all the units at all times even in a state that the back end unit is not used for a long period of time by the setting as described above, and thus power is unnecessarily consumed.

### SUMMARY

According to an aspect of the invention, a virtual tape apparatus for connecting a tape apparatus for storing data to a physical tape includes a cache for storing data, a power supply determination unit for determining whether it is necessary to supply power to the tape apparatus based on a update state of the data stored in the cache, and a power switching unit for switching a state of power supply to the tape apparatus based on a result of determination of the power supply determination unit.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating an arrangement of a well-known virtual tape library system having the virtual tape apparatus;

FIG. 2 is a view illustrating a well-known control between respective functions of the virtual tape apparatus and a flow of data;

FIG. 3 is a view illustrating an arrangement of a virtual tape library system having a virtual tape apparatus of an embodiment;

FIG. 4 is a view illustrating an outline of a process when designation of an updated-data passed period of time is valid in the embodiment;

FIGS. 5A to 5C are views illustrating an outline of a process when designation of an updated-data capacity is valid in the embodiment;

FIG. 6 is a flowchart illustrating a process for determining whether or not setting of the updated-data passed period of time is valid in the embodiment; and

FIG. 7A to 7D are a flowchart illustrating a process for determining and controlling power supplied to a back end unit according to the updated-data passed period of time and the updated data capacity of the embodiment.

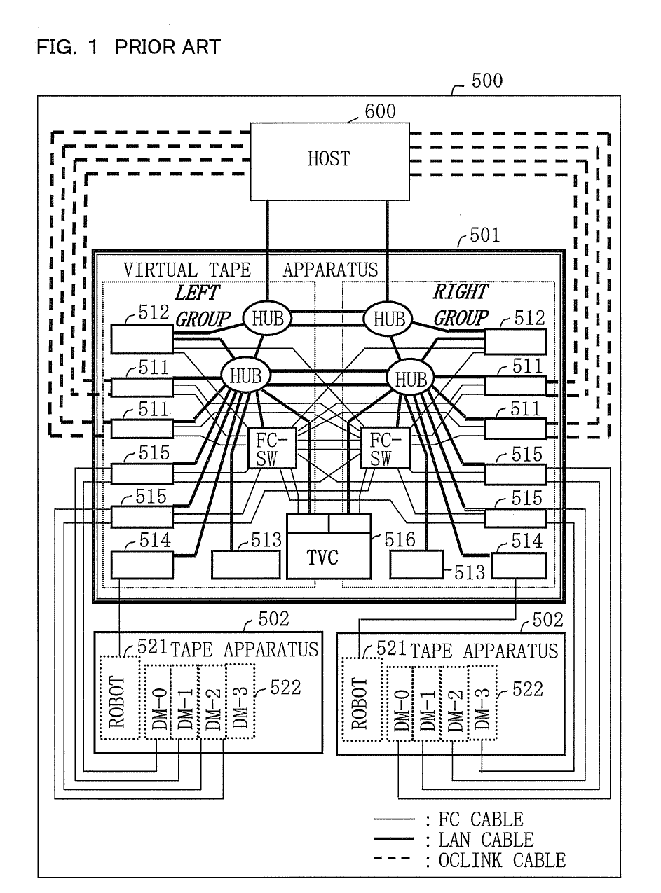

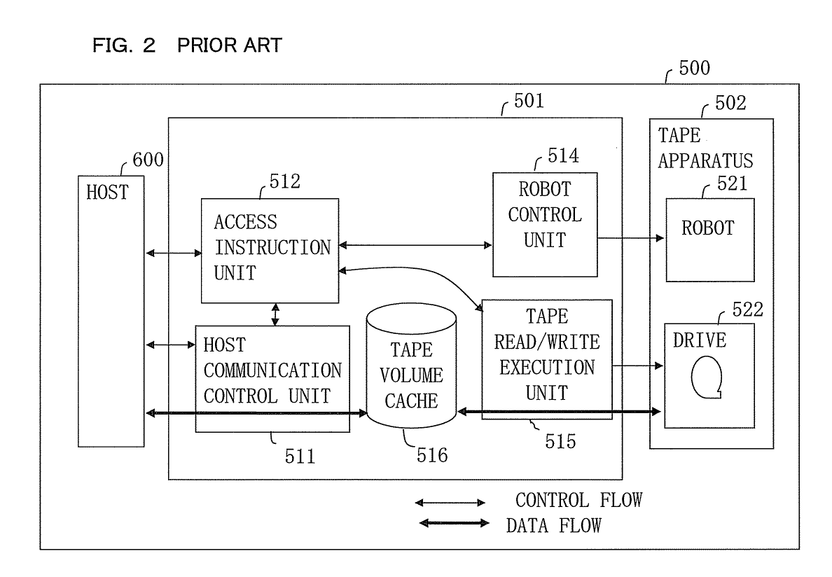

### DESCRIPTION OF EMBODIMENT

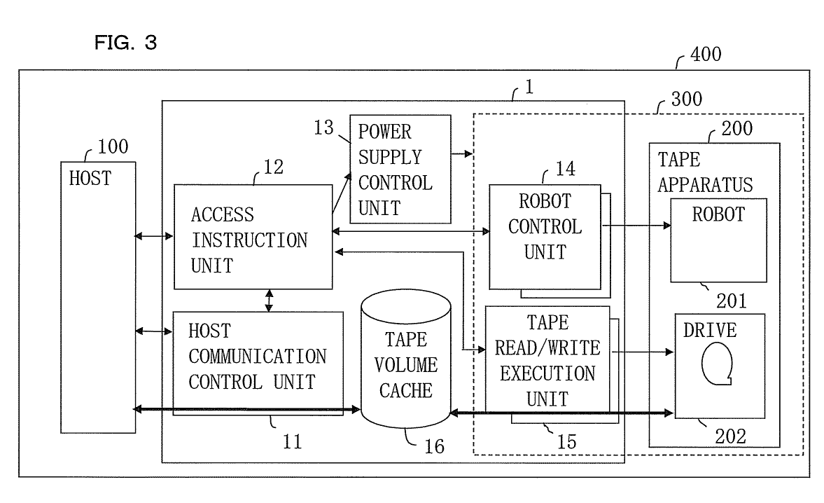

FIG. 3 illustrates a virtual tape library system 400 having a virtual tape apparatus 1 of an embodiment of the present invention. Note that although the virtual tape library system 400 of the embodiment does not employ a redundant arrangement to simplify explanation, it may be an arrangement employing the plurality of systems described above. Further, in FIG. 3, thick arrows show a flow of data and thin arrows show a flow of control.

The virtual tape library system 400 has the virtual tape apparatus 1, a host 100, and a tape apparatus 200. The virtual tape apparatus 1 has a host communication control unit 11, an access instruction unit 12, a power supply control unit 13, a robot control unit 14, a tape read/write execution unit 15 (an example of a data communication control unit), a tape volume cache 16. Further, it is assumed that the respective arrangements of the virtual tape apparatus 1 described above are composed of servers having individual cabinets, respectively.

The host communication control unit 11 is connected to the host 100 and controls data transmission/reception between the host 100 and logical volumes on the tape volume cache 16.

The access instruction unit 12 stores data to a physical tape and restores data from the physical tape by instructing the tape read/write execution unit 15 and the robot control unit 14 to access to the physical tape. The access instruction unit 12 receives a mount request from the host 100 and mounts the logical volumes of the tape volume cache 16. The access instruction unit 12 determines whether or not a data request from the host 100 is present on the tape volume cache 16. When the data is not present, the access instruction unit 12 instructs the tape read/write execution unit 15 and the robot control unit 14 to transmit data from the physical tape in the tape apparatus 200 to the tape volume cache 16. After the completion of data transmission from the physical tape to the tape volume cache 16, the access instruction unit 12 instructs the host communication control unit 11 to transmit and receive data to and from the host 100. The access instruction unit 12 requests the tape read/write execution unit 15 and the robot control unit 14 to write data updated by the host 100 on the tape volume cache 16 to the physical tape in the tape apparatus 200, and the tape read/write execution unit 15 and the robot control unit 14 write the updated data to the physical tape.

Further the access instruction unit 12 (an example of a power supply determination unit) of the embodiment determines whether or not it is necessary to supply power to the tape apparatus 200 based on a data update state stored to the tape volume cache 16 of the virtual tape apparatus 1. Note that the access instruction unit 12 is also provided with a function for monitoring a passed time and an updated data capacity which are described later.

The power supply control unit 13 controls ON/OFF of power supplies of respective servers in the virtual tape apparatus 1. Further the power supply control unit 13 (an example of a power switching unit) of the embodiment switches (turns ON/OFF) the power supplied to the tape apparatus 200 based on a result determination executed by the access instruction unit 12. Note that, in the embodiment, the power supply control unit 13 is connected to the tape apparatus 200 through an interface (for example, a serial cable terminal) commonly provided therewith. Although it is assumed that a switching signal for switching power to be supplied is transmitted through the above connection, a mode for switching it is not limited thereto.

The robot control unit 14 controls a robot 201 of the tape apparatus 200 in response to instruction from the access instruction unit 12.

The tape read/write execution unit 15 stores the logical volumes in the tape volume cache 16 to the physical tape by controlling a drive 202 of the tape apparatus 200 in response to instruction from the access instruction unit 12. Further, the tape read/write execution unit 15 reads out data of the physical tape stored to the tape apparatus 200 and restores it on the tape volume cache 16.

The tape volume cache 16 is a magnetic disc apparatus composed of RAID, and the data of the logical volumes is stored thereto.

The tape apparatus 200 stores the physical tape, obtains data from an outside (tape volume cache 16) using the robot 201 and the drive 202 disposed therein and stores the data to the physical tape. Further, the tape apparatus 200 restores the data of the physical tape to the outside (tape volume cache 16).

Further, in the embodiment, the tape apparatus 200, the robot control unit 14, and the tape read/write execution unit 15 are arranged as a back end unit 300.

Next, an outline of processes of the access instruction unit 12 and the power supply control unit 13 will be explained. While it is recognized and determined that the back end unit 300 need not be processed by the access instruction unit 12, the power supply control unit 13 turns OFF a power supply of the back end unit 300, and an operation is executed only on the tape volume cache 16. Further, when the access instruction unit 12 recognizes and determines that an access to the physical tape is necessary, the power supply control unit 13 turns on the power supply of the back end unit 300.

Note that when the access instruction unit 12 determines that logical volumes stored to the tape volume cache 16 are not updated for a predetermined period of time, it may determine that the back end unit 300 need not be processed. The power supply control unit 13 turns off the power supply of the back end unit 300 also in this case. Note that the access instruction unit 12 holds an update time of each logical volume each time a data update process is executed and determines a passed time by comparing the time with the present time.

Next, how the access instruction unit 12 determines whether or not it is necessary to supply power will be explained. The access instruction unit 12 determines whether or not it is necessary to supply power based on an updated-data passed period of time of the tape volume cache 16 and a capacity of updated data stored to the tape volume cache 16. Although the updated-data passed period of time means a period of time passed from the time at which the logical volumes whose data is updated is stored to the tape volume cache 16, it may be a period of time passed from the time at which the data of the logical volumes are written on the tape volume cache 16. The updated data is the data in the tape volume cache 16 which is not stored to the physical tape in the tape apparatus 200. Note that the updated-data passed period of time and the capacity of the updated data (upper limit capacity, lower limit capacity) are set by the user.

The access instruction unit 12 monitors the updated-data passed period of time or the capacity of the updated data on the tape volume cache 16 based on the set values described above, and when the access instruction unit 12 determines that the physical tape is not accessed for at least a predetermined period of time, it instructs the power supply control unit 13 to turn off the power supply to the back end unit 300.

A power supply control based on the updated-data passed period of time of the tape volume cache 16 will be explained here. The virtual tape library system 400 writes the logical volumes in the tape volume cache 16 to the physical tape after a designated time (updated-data passed period of time designated by the user) has passed from the time at which the logical volumes were updated. Note that the virtual tape apparatus 1 can set whether the power supply control is made valid or invalid based on the updated-data passed period of time, and when the power supply control is set valid, the virtual tape apparatus 1 can further designate an arbitrary period of time from “1 minute” to “1440 minutes”. Further, when the power supply control is set invalid, the virtual tape apparatus 1 executes writing to the physical tape at once when the logical volumes in the tape volume cache 16 are updated.

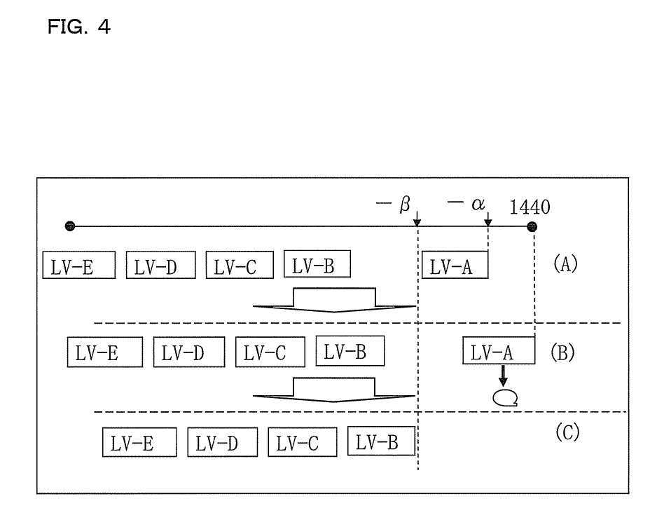

An outline of a process of the virtual tape apparatus 1 when the power supply control is used based on the updated-data passed period of time will be explained referring to FIG. 4. Note that, in the following explanation referring to FIG. 4, it is assumed that logical volumes LV-A to LV-E are stored to the tape volume cache 16, and a case that the logical volume LV-A has reached the updated-data passed period of time will be explained. Further, it is assumed that a designated updated-data passed period of time is set to 1440 minutes (24 hours).

Power supplies of the respective units of the back end unit 300 are turned on before α hours of a designated updated-data passed period of time after the logical volume LV-A is updated (updated-data passed period of time−α hours=first period). Refer to (A) of FIG. 4. Note that the α hours is a period of time (period of time necessary to an initialization process) which is set taking a period of time, which is necessary for the respective units of the back end unit 300 to operate normally after the power supplies are turned on, into consideration.

After the α hours have passed after the power supplies were turned on (that is, after the designated updated-data passed period has passed from the time logical volume LV-A was updated), the logical volume LV-A is written to the physical tape. Refer to (B) of FIG. 4.

Further, the power supply of the back end unit 300 is turned off when the data of the logical volume, which has reached the designated updated-data passed period of time, is written to the physical tape and the updated-data passed period of time of other logical volume is equal to or less than 1440−β (β is a period of time set to guarantee a power off state of at least a predetermined period of time so that power is not supplied just after the power supply is turned off, and β hours≧α hours). Refer to (C) of FIG. 4.

That is, after the power supply is turned off, the access instruction unit 12 does not instruct to turn on the power supply from the time a to the time β (β−α) in FIG. 4 (second period).

Next, the power supply control executed based on the updated data capacity stored to the tape volume cache 16 will be explained.

When the updated data on the tape volume cache 16 exceeds a designated upper limit capacity, the updated logical volume on the tape volume cache 16 is written to the physical tape until the capacity of the updated data decreases to a designated lower limit capacity. Note that it is assumed that the upper limit capacity and the lower limit capacity is designated as a ratio (1-100(%)) of the capacity of the updated logical volume to the capacity of all the logical volumes stored in the tape volume cache 16. However, the ratio may be the ratio of the capacity of the updated logical volume to the overall allowable capacity that can be stored to the tape volume cache 16 or the ratio of the capacity of the updated logical volume to the capacity of the non-updated logical volumes.

Further, when an update frequency of the logical volumes of the tape volume cache 16 is low at the time timing of writing data to the physical tape is set only by the updated data capacity, a state that data is not written to the physical tape for a long period of time occurs. Accordingly, although it is assumed that the virtual tape apparatus 1 makes setting of the updated data capacity valid when the updated-data passed period of time is set valid, only the updated data capacity may be designated without providing the setting of the updated-data passed period of time. Further, the virtual tape apparatus 1 may make the setting of the updated data capacity invalid.

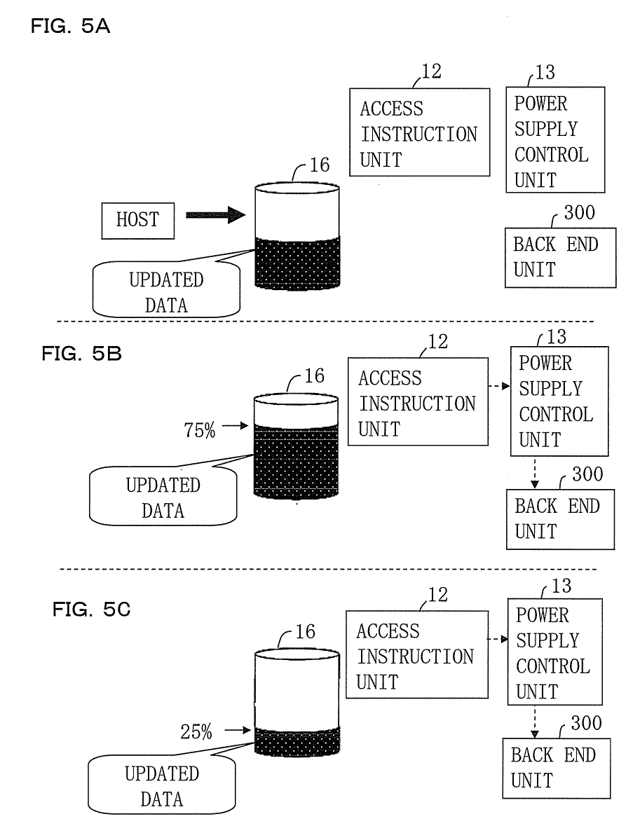

An outline of a power supply control process of the virtual tape apparatus 1 when the setting of the updated data capacity is used will be explained referring to FIGS. 5A to 5C. Note that, in the explanation referring to FIGS. 5A to 5C, although the upper limit capacity is set to 75(%) and the lower limit capacity is set to 25(%), the present technique is not limited to this mode.

The logical volumes in the tape volume cache 16 are updated each time logical volumes are created (data is updated) in response to an instruction from the host 100 (refer to FIG. 5A). When the access instruction unit 12 determines that the updated data capacity on the tape volume cache 16 reaches 75(%), the power supply control unit 13 turns on the power supply of the back end unit 300 (refer to FIG. 5B). When the access instruction unit 12 determines that the updated data capacity on the tape volume cache 16 has reached 25(%) or less by that the updated data is written to the physical tape, the power supply control unit 13 turns off the power supply of the back end unit 300 (refer to FIG. 5C).

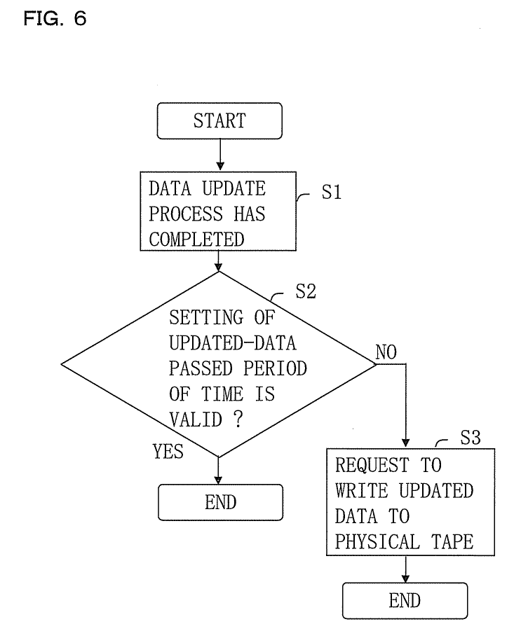

Next, processes of the virtual tape apparatus 1 of the embodiment will be explained referring to flowcharts of FIGS. 6 to 9.

First, a process, which determines whether or not the setting of the updated-data passed period of time is valid or invalid, will be explained based on FIG. 6.

When a data update process from the host 100 to the tape volume cache 16 has completed (step S1), the access instruction unit 12 determines whether the setting of the updated-data passed period of time is valid or invalid (step S2). When the setting is invalid (step S2, NO), the access instruction unit 12 requests the robot control unit 14 and the tape read/write execution unit 15 for writing the updated data to the physical tape to instantly write it to the physical tape (step S3), and a write process is executed. Note that since it may take a long period of time to write the updated data to the physical tape, the access instruction unit 12 may request only to write the updated data, and the updated data may be actually written to the physical tape based on a scheduler function of the tape apparatus 200 and the like (this is the same at steps S17, S22).

As described above, when the setting of the updated-data passed period of time is invalid, the updated logical volume is written to the physical tape each time it is updated.

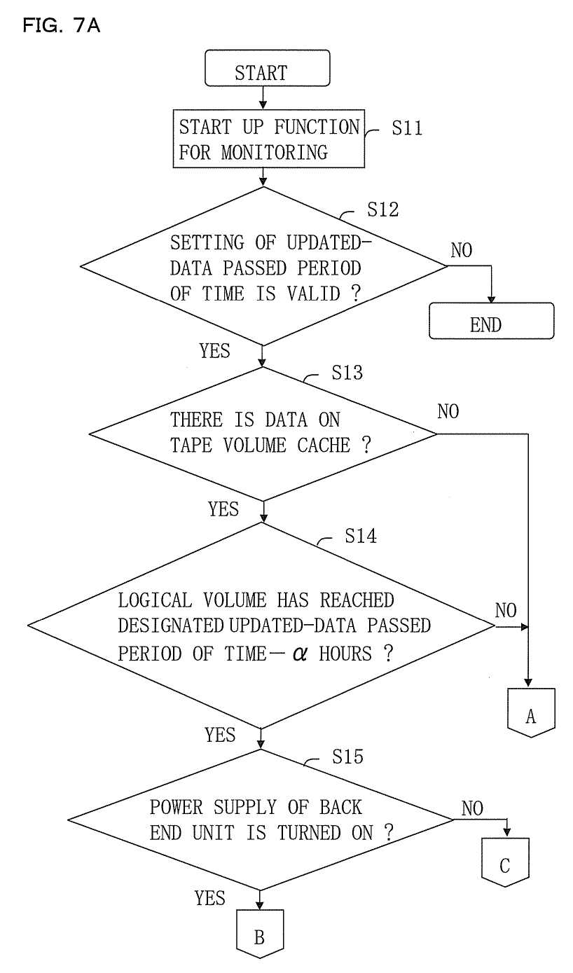

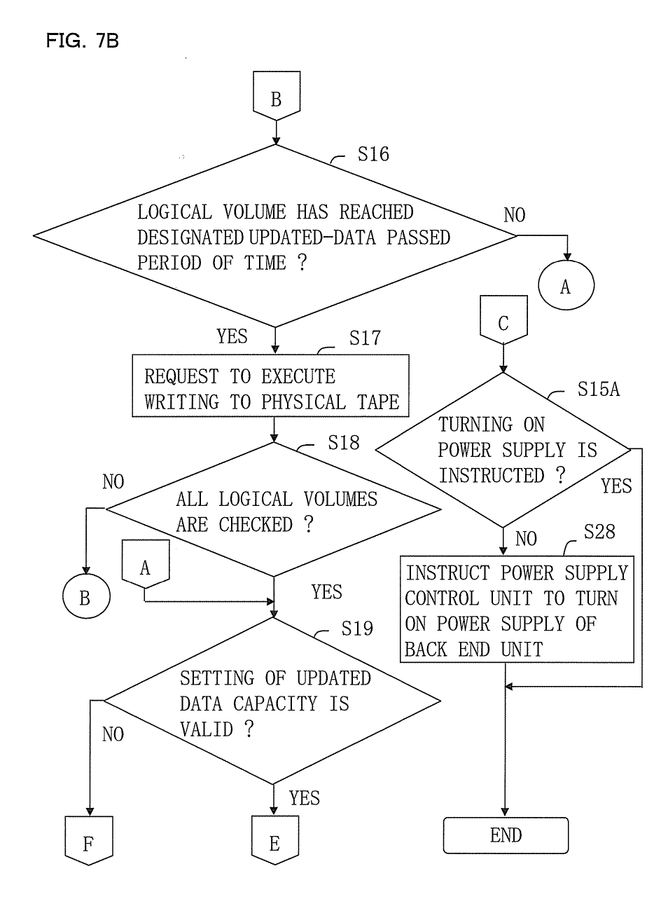

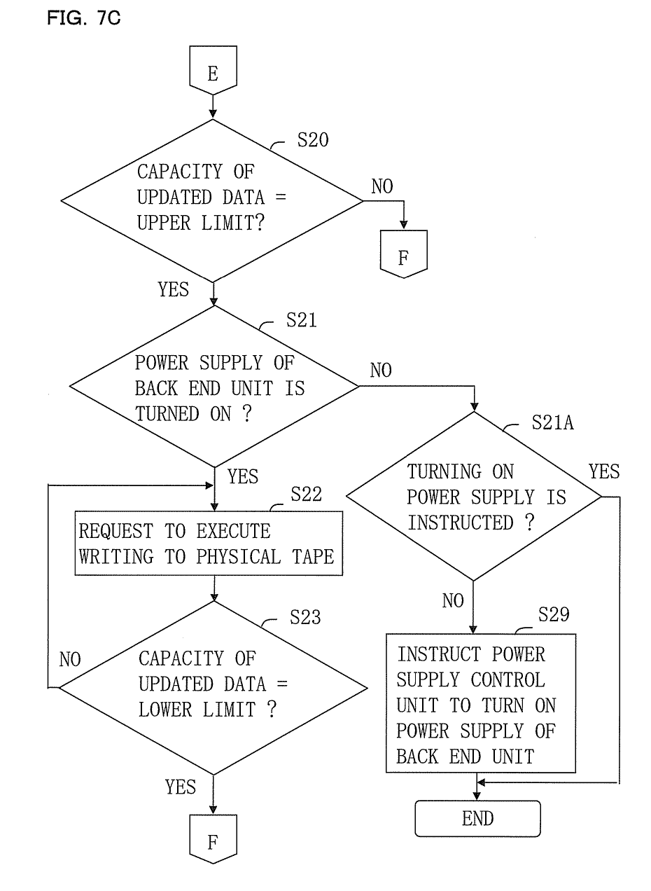

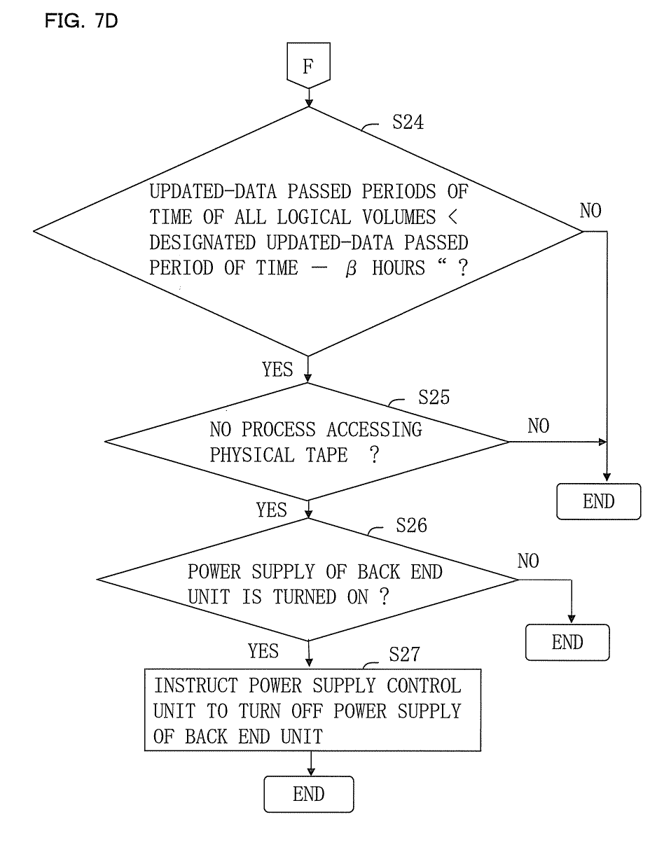

Note that when the setting of the updated-data passed period of time is valid (step S3, YES), the process is finished as it is without executing any operation because a determination whether or not power is supplied and the control of the supplied power are executed by the processes shown in the flowcharts of FIG. 7A and subsequent figures.

Next, the determination process of writing to the physical tape based on the updated-data passed period of time and the updated data capacity and the power supply control process will be explained referring to FIGS. 7A, 7B, 7C, 7D.

The access instruction unit 12 starts up a function for monitoring the updated-data passed period of time and the updated data capacity at intervals of one minutes (step S11). The monitoring function may be a part of a program of the access instruction unit 12 or may be a process other than that of the access instruction unit 12. The access instruction unit 12 determines whether the setting of the updated-data passed period of time is valid or invalid (step S12). When the setting of the updated-data passed period of time is invalid (step S12, NO), the process is finished, whereas when the setting of the updated-data passed period of time is valid (step S12, YES), the access instruction unit 12 determines whether or not there is data, which is not written to the physical tape, on the tape volume cache 16 (step S13).

When there is data which is not written to the physical tape (step S13: YES), the access instruction unit 12 determines whether or not there is a logical volume which has reached “the designated updated-data passed period of time−αhours” (step S14). When there is a logical volume which has reached “the designated updated-data passed period of time−αhours” (step S14: YES), the access instruction unit 12 determines whether or not the power supply of the back end unit 300 has been turned on using, for example, a power supply state controlled by the power supply control unit 13 as a material of determination (step S15).

When power supply is not turned on (step S15: NO), the access instruction unit 12 determines whether or not it is instructed to turn on the power supply of the back end unit 300 (step S15A). When it is not instructed (step S15A: No), the access instruction unit 12 instructs the power supply control unit 13 to turn on the power supply of the back end unit 300, and the power supply control unit 13 turns on the power supply of the back end unit 300 (step S28). Note that since the monitoring process is started up at the intervals of one minute, the processes at step S16 and subsequent processes are executed by repeatedly executing the processes at step S11 and subsequent processes after the completion of the process at step S28.

When the power supply of the back end unit 300 is turned on (step S15: YES), the access instruction unit 12 determines whether or not there is a logical volume which has reached the updated-data passed period of time (step S16). When there is a logical volume which has reached the designated updated-data passed period of time (step S16: YES), the access instruction unit 12 requests the tape read/write execution unit 15 and the robot control unit 14 to execute writing to the physical tape (step S17), and the updated logical volume is written to the physical tape.

The access instruction unit 12 determines whether or not the updated-data passed periods of time of all the logical volumes in a data updated state are checked (step S18), when there is an unchecked logical volume (step S18: NO), the process returns to step S16.

When the updated-data passed periods of time of all the logical volumes are checked and there is no logical volume which exceeds the updated-data passed period of time designated by the user (step S18: YES), the access instruction unit 12 determines whether the setting of the updated data capacity is valid or invalid next (step S19). When the setting of the updated data capacity is valid (step S19: YES), the access instruction unit 12 determines whether or not the capacity of the updated data has reached the upper limit capacity (step S20).

When the capacity of the updated data has reached the upper limit capacity (step S20: YES), the access instruction unit 12 determines whether or not the power supply of the back end unit 300 has been turned on (step S21).

When the power supply of the back end unit 300 has not been turned on (step S21: NO), the access instruction unit 12 determines whether or not it is instructed to turn on the power supply of the back end unit 300 (step S21A). When it is not instructed to turn on the power supply (step S21A, No), the access instruction unit 12 instructs the power supply control unit 13 to turn of the power supply of the back end unit 300, and the power supply control unit 13 turns on the power supply of the back end unit 300 (step S29). Note that since the monitoring process is started up at the intervals of one minute, the processes at step S22 and subsequent processes are executed by repeatedly executing the processes at step S11 and subsequent processes after the completion of the process at step S29.

In contrast, when the power supply of the back end unit 300 is turned on (step S21: YES), the access instruction unit 12 requests the tape read/write execution unit 15 and the robot control unit 14 to execute writing to the physical tape (step S22), and writing is executed to the physical tape of the updated logical volume.

The process at step S22 is executed until the updated data capacity reaches the lower limit capacity (loop from step S23: No to step S22).

When the updated logical volume, which is updated to the lower limit capacity, is written (step S23: YES), the access instruction unit 12 determines whether or not the updated-data passed periods of time of all the logical volumes in the data updated state are shorter than “the designated updated-data passed period of time−β hours” (step S24). When the updated-data passed period of time is equal to or longer than “the designated updated-data passed period of time−β hours” (step S24: NO), the process is finished, whereas when the updated-data passed period of time is shorter than “the designated updated-data passed period of time−β hours” (step S24: YES), the access instruction unit 12 determines whether or not there is a process accessing the physical tape (step S25). When there is the process accessing the physical tape (step S25, NO), the process is finished, whereas when there is not the process accessing the physical tape (step S25: YES), the access instruction unit 12 determines whether or not the power supply of the back end unit 300 is turned on (step S26).

When the power supply of the back end unit 300 is not turned on (step S26: NO), the process is finished, whereas when the power supply of the back end unit 300 is turned on (step S26: YES), the access instruction unit 12 instructs the power supply control unit 13 to turn off the power supply of the back end unit 300, and the power supply control unit 13 turns off the power supply to the back end unit 300 (step S27).

Note that when the determinations at steps S13, S14, and S16 are NO, the process goes to step S19, whereas when the determinations at steps S19 and S20 are NO, the process goes to step S24.

In the embodiment, although the tape read/write execution unit 15, the robot control unit 14, and the tape apparatus 200 constitute the back end unit 300, the mode of the back end unit 300 is not limited thereto. When a virtual tape apparatus cannot control to supply power only to, for example, a tape read/write execution unit and a robot control unit, only a tape apparatus may constitute a back end unit, and power may be controlled such that it is supplied only to the tape apparatus.

Further, although the virtual tape library system 400 of the embodiment is arranged to include the host 100, only the virtual tape apparatus and the tape apparatus may be used as units constituting the virtual tape library system 400 without including the host.

In the embodiment, it is explained to turn on and off the power supply as an example of a power supply state. However, when a suspend function (low power mode) is provided with the tape apparatus, a state of power supply, which is necessary to suspend the tape apparatus, and a state of power supply, which permits the tape apparatus to operate ordinarily (at least a data communication to the physical tape can be executed) may be switched.

In the embodiment, the time passed after data is updated and the capacity of the updated data are explained as an example of the updated state of the data stored to the tape volume cache 16. However, this does not limit the mode of the present technique, and, for example, the update of data executed by restoring data from the tape apparatus 200 to the tape volume cache 16 may be used as the updated state.

Since the power supply of the back end unit is turned off during a period time in which it is determined that the physical tape is not accessed by the virtual tape apparatus and the virtual tape library system of the embodiment, power consumption can be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A virtual tape apparatus for connecting a tape apparatus for storing data to a physical tape, the virtual tape apparatus comprising:
a cache for storing data;
a power supply determination unit for determining whether it is necessary to supply power to the tape apparatus based on a update state of the data stored in the cache; and
a power switching unit for switching a state of power supply to the tape apparatus based on a result of determination of the power supply determination unit.

2. The virtual tape apparatus according to claim 1, wherein the power supply determination unit determines that it is necessary to supply power when a first period of time has passed after the data in the cache is updated, and further when the power supply determination unit determines that the physical tape is not accessed during a second period after the data in the cache is updated, the power supply determination unit determines that it is not necessary to supply power.

3. The virtual tape apparatus according to claim 1, wherein when the capacity of updated data, which is data in the cache and is not stored to the physical tape in the tape apparatus, reaches a predetermined upper limit capacity, the power supply determination unit determines that it is necessary to supply power, and when the capacity of the updated data in the cache is made to a predetermined lower limit capacity by that the updated data is stored to the physical tape of the tape apparatus, the power supply determination unit determines that it is not necessary to supply power.

4. The virtual tape apparatus according to claim 1, further comprising:
a robot control unit for controlling a robot disposed to the tape apparatus; and
a data communication control unit for controlling a data communication between the cache and the physical tape in the tape apparatus,
wherein the power switching unit switches power supply states to the robot control unit and the data communication control unit based on a result of determination executed by the power supply determination unit.

5. The virtual tape apparatus according to claim 1, wherein when the power supply determination unit determines that it is necessary to supply power, the power switching unit switches a power supply from an OFF state to an ON state, and when the power supply determination unit determines that it is not necessary to supply power, the power switching unit switches the power supply from the ON state to the OFF state.

6. The virtual tape apparatus according to claim 1, wherein when the power supply determination unit determines that it is necessary to supply power, the power switching unit switches a state of power supply necessary to a suspended state of the tape apparatus to at least to a state of power supply necessary to a data communication to the physical tape, and when the power supply determination unit determines that it is not necessary to supply power, the power switching unit switches the state of power supply necessary to the data communication to at least the physical tape to the state of power supply necessary to the suspended state of the tape apparatus.

7. A virtual tape library system comprising a tape apparatus, in which a physical tape is stored and which stores data to the physical tape, and a virtual tape apparatus which holds data to be stored to the physical tape to a cache of the virtual tape apparatus, the virtual tape apparatus comprising:
a power supply determination unit for determining whether or not it is necessary to supply power to the tape apparatus based on an update state of the data stored to the cache; and
a power switching unit for switching a state of power supply to the tape apparatus based on a result of determination executed by the power supply determination unit.

8. The virtual tape library system according to claim 7, wherein the power supply determination unit determines that it is necessary to supply power when a first period of time has passed after the data in the cache is updated, and further when the power supply determination unit determines that the physical tape is not accessed during a second period after the data in the cache is updated, the power supply determination unit determines that it is not necessary to supply power.

9. The virtual tape library system according to claim 7, wherein when the capacity of updated data, which is data in the cache and is not stored to the physical tape in the tape apparatus, reaches a predetermined upper limit capacity, the power supply determination unit determines that it is necessary to supply power, and when the capacity of the updated data in the cache is made to a predetermined lower limit capacity by that the updated data is stored to the physical tape of the tape apparatus, the power supply determination unit determines that it is not necessary to supply power.

10. The virtual tape library system according to claim 7, wherein the virtual tape apparatus further comprises:
a robot control unit for controlling a robot disposed to the tape apparatus; and
a data communication control unit for controlling a data communication between the cache and the physical tape in the tape apparatus,
wherein the power switching unit switches power supply states to the robot control unit and the data communication control unit based on a result of determination executed by the power supply determination unit.

11. The virtual tape library system according to claim 7, wherein when the power supply determination unit determines that it is necessary to supply power, the power switching unit switches a power supply from an OFF state to an ON state, and when the power supply determination unit determines that it is not necessary to supply power, the power switching unit switches the power supply from the ON state to the OFF state.

12. The virtual tape library system according to claim 7, wherein when the power supply determination unit determines that it is necessary to supply power, the power switching unit switches a state of power supply necessary to a suspended state of the tape apparatus to a state of power supply necessary to a data communication to at least the physical tape, and when the power supply determination unit determines that it is not necessary to supply power, the power switching unit switches the state of power supply necessary to the data communication to at least the physical tape to a state of power supply necessary to the suspended state of the tape apparatus.

13. A method for controlling power supply, comprising the step of:
a power supply determination step of determining whether or not it is necessary to supply power to a tape apparatus in which a physical tape is stored and which stores data to the physical tape based on an update state of the data stored in a cache of a virtual tape apparatus; and
a power switching step of switching a state of power supply to the tape apparatus based on a result of determination at the power supply determination step.

14. The method according to claim 13, wherein the power supply determination step determines that it is necessary to supply power when a first period of time has passed after the data in the cache is updated, and further when the power supply determination unit determines that the physical tape is not accessed during a second period after the data in the cache is updated, the power supply determination unit determines that it is not necessary to supply power.

15. The method according to claim 13, wherein when the capacity of updated data, which is data in the cache and is not stored to the physical tape in the tape apparatus, reaches a predetermined upper limit capacity, the power supply determination step determines that it is necessary to supply power, and when the capacity of the updated data in the cache is made to a predetermined lower limit capacity by that the updated data is stored to the physical tape of the tape apparatus, the power supply determination step determines that it is not necessary to supply power.

16. The method according to claims 13, wherein the virtual tape apparatus further comprises:
a robot control unit for controlling a robot disposed to the tape apparatus; and
a data communication control unit for controlling a data communication between the cache and the physical tape in the tape apparatus,
wherein the power switching step further switches power supply states to the robot control unit and the data communication control unit based on a result of determination executed by the power supply determination step.

17. The method according to claims 13, wherein when the power supply determination step determines that it is necessary to supply power, the power switching step switches the power supply from an OFF state to an ON state, and when the power supply determination step determines that it is not necessary to supply power, the power switching step switches the power supply from the ON state to the OFF state.

18. The method according to claims 13, wherein when the power supply determination step determines that it is necessary to supply power, the power switching step switches a state of power supply necessary to the suspended state of the tape apparatus to a state of power supply necessary to a data communication to at least the physical tape, and when the power supply determination step determines that it is not necessary to supply power, the power switching step switches the state of power supply necessary to the data communication to at least the physical tape to the state of power supply necessary to the suspended state of the tape apparatus.
